(19) United States
(12) Patent Application Publication
(10) Pub. No.: US 2025/0371939 A1
(43) Pub. Date: Dec. 4, 2025

(54) PAYTABLE MODIFICATIONS FOR WAGERING GAMES USING CRYPTOGRAPHIC TOKENS

(71) Applicant: IGT, Las Vegas, NV (US)

(72) Inventors: Karen VAN NIEKERK, Dieppe (CA); Todd GRIMM, Riverview (CA); Bethany PLIMMER, Lower Coverdale (CA); Aaron COREY, Moncton (CA); Daniel LANDRY, Moncton (CA); Michael RUSS, Graz (AT); Gaurav JARIWALA, Halifax (CA)

(73) Assignee: IGT, Las Vegas, NV (US)

(21) Appl. No.: 18/677,366

(22) Filed: May 29, 2024

(51) Int. Cl. G07F 17/32

(52) U.S. Cl. CPC G07F 17/3244

(57) ABSTRACT

A method includes determining, by a processor circuit, a cryptographic token associated with a player at a gaming device. The method further includes modifying, by the processor circuit, a paytable for a wagering game at the gaming device from a first paytable to a second paytable associated with the cryptographic token. The method further includes receiving, by the processor circuit, a wager for the wagering game from the player at the gaming device. The method further includes determining, by the processor circuit, whether an outcome for the wagering game is a winning outcome. The method further includes, in response to a determination that the outcome for the wagering game is a winning outcome, determining, by the processor circuit, a game award for the wagering game based on the wager and the second paytable. The method further includes awarding, by the processor circuit, the game award to the player.

### BACKGROUND

Embodiments described herein relate to game play features with wagering games, and in particular to paytable modifications for wagering in a gaming environment, such as in a casino environment, using cryptographic tokens, and related devices, systems, and methods. Some wagering games, such as slot games and/or video poker games provided at Electronic Gaming Machines (EGMs) and/or mechanical gaming devices in a casino environment, may include unique game features as an additional incentive for play of a wagering game. There is a need address these and other technical problems for providing additional options for player interaction and enjoyment to encourage wagering game play.

### BRIEF SUMMARY

According to some embodiments, a system includes a processor circuit and a memory coupled to the processor circuit. The memory includes machine-readable instructions that, when executed by the processor circuit, cause the processor circuit to determine a cryptographic token associated with a player at a gaming device. The instructions further cause the processor circuit to modify a paytable for a wagering game at the gaming device from a first paytable to a second paytable associated with the cryptographic token. The instructions further cause the processor circuit to receive a wager for the wagering game from the player at the gaming device. The instructions further cause the processor circuit to determine whether an outcome for the wagering game is a winning outcome. The instructions further cause the processor circuit to, in response to a determination that the outcome for the wagering game is a winning outcome, determine a game award for the wagering game based on the wager and the second paytable. The instructions further cause the processor circuit to award the game award to the player.

According to some embodiments, a gaming device includes a communication interface, an input device, a processor circuit, and a memory coupled to the processor circuit. The memory includes machine-readable instructions that, when executed by the processor circuit, cause the processor circuit to determine, via the communication interface, a cryptographic token associated with a player at a gaming device. The instructions further cause the processor circuit to modify a paytable for a wagering game at the gaming device from a first paytable to a second paytable associated with the cryptographic token. The instructions further cause the processor circuit to receive, via the input device, a wager for the wagering game from the player at the gaming device. The instructions further cause the processor circuit to determine whether an outcome for the wagering game is a winning outcome. The instructions further cause the processor circuit to, in response to a determination that the outcome for the wagering game is a winning outcome, determine a game award for the wagering game based on the wager and the second paytable. The instructions further cause the processor circuit to award the game award to the player.

According to some embodiments, a method includes determining, by a processor circuit, a cryptographic token associated with a player at a gaming device. The method further includes modifying, by the processor circuit, a paytable for a wagering game at the gaming device from a first paytable to a second paytable associated with the cryptographic token. The method further includes receiving, by the processor circuit, a wager for the wagering game from the player at the gaming device. The method further includes determining, by the processor circuit, whether an outcome for the wagering game is a winning outcome. The method further includes, in response to a determination that the outcome for the wagering game is a winning outcome, determining, by the processor circuit, a game award for the wagering game based on the wager and the second paytable. The method further includes awarding, by the processor circuit, the game award to the player.

BRIEF DESCRIPTION OF SEVERAL VIEWS OF THE DRAWINGS

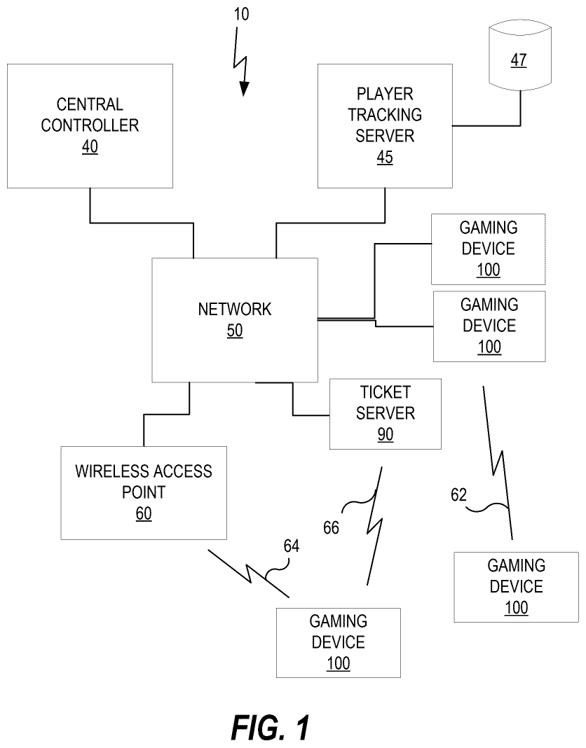

FIG. 1 is a schematic block diagram illustrating a network configuration for a plurality of gaming devices according to some embodiments.

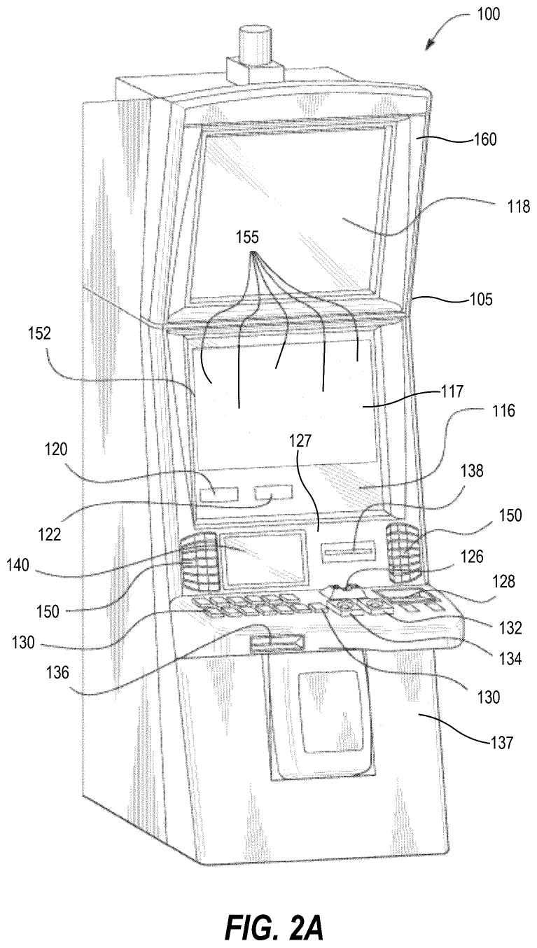

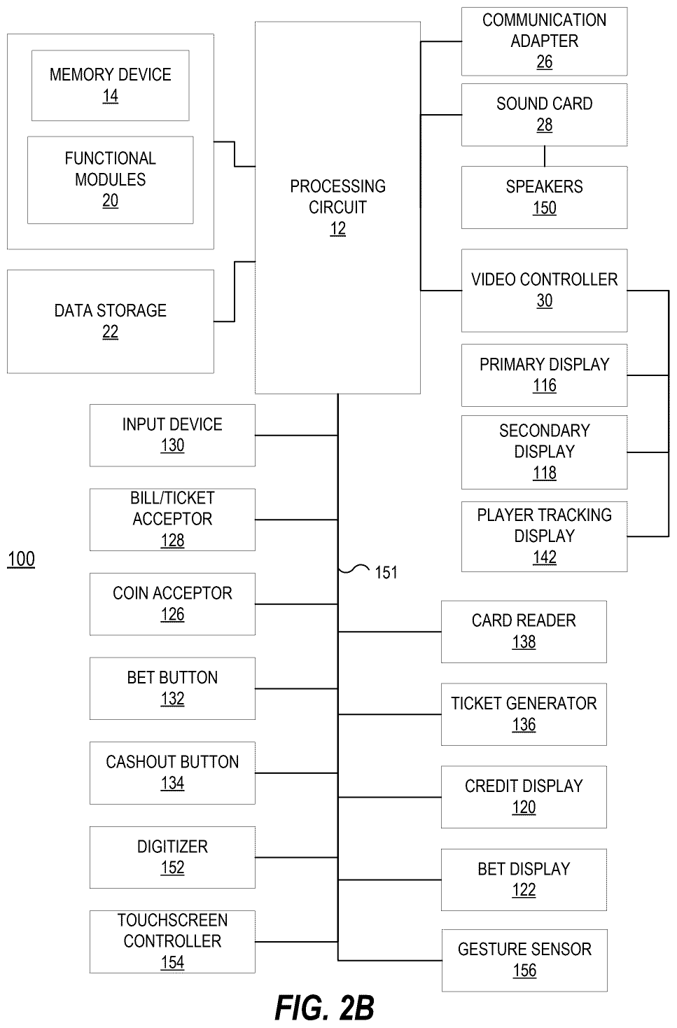

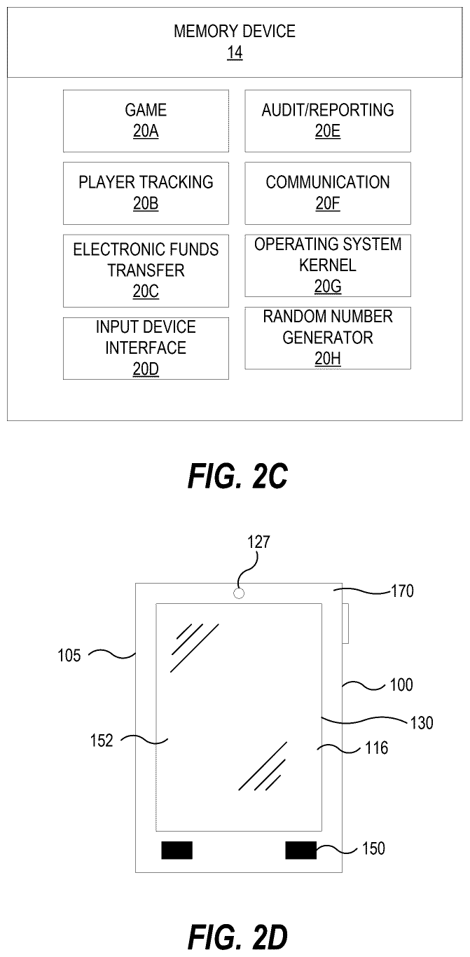

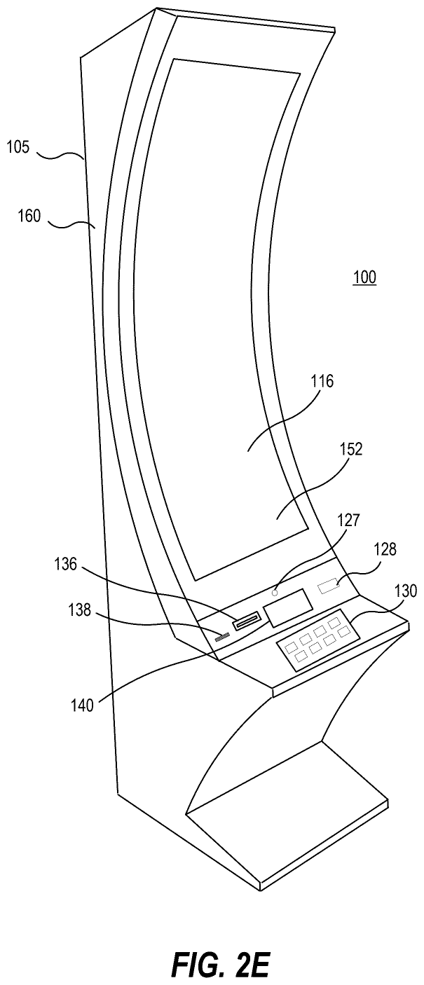

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

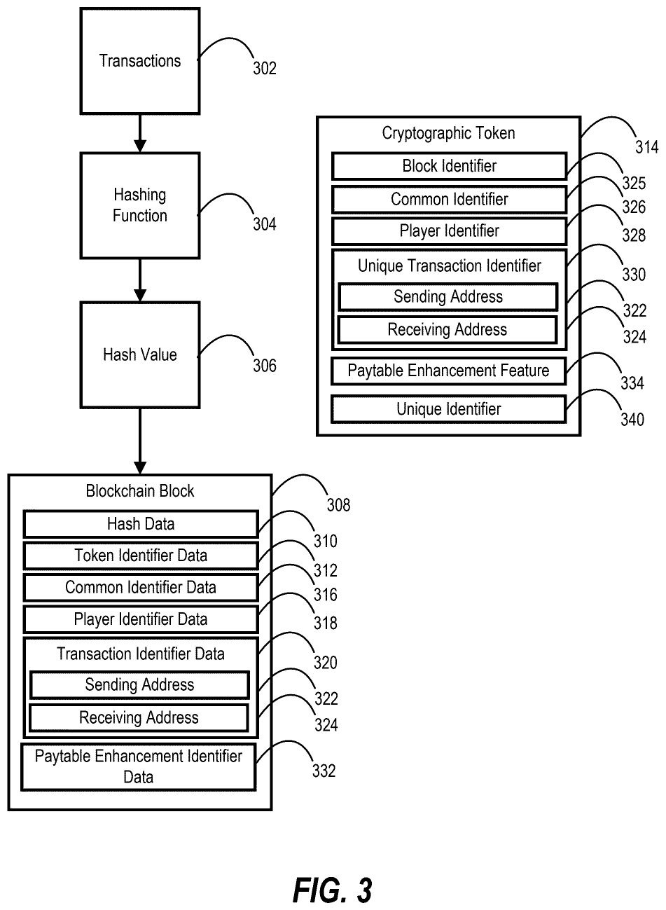

FIG. 3 is a schematic block diagram illustrating various operations for a blockchain token transaction according to some embodiments.

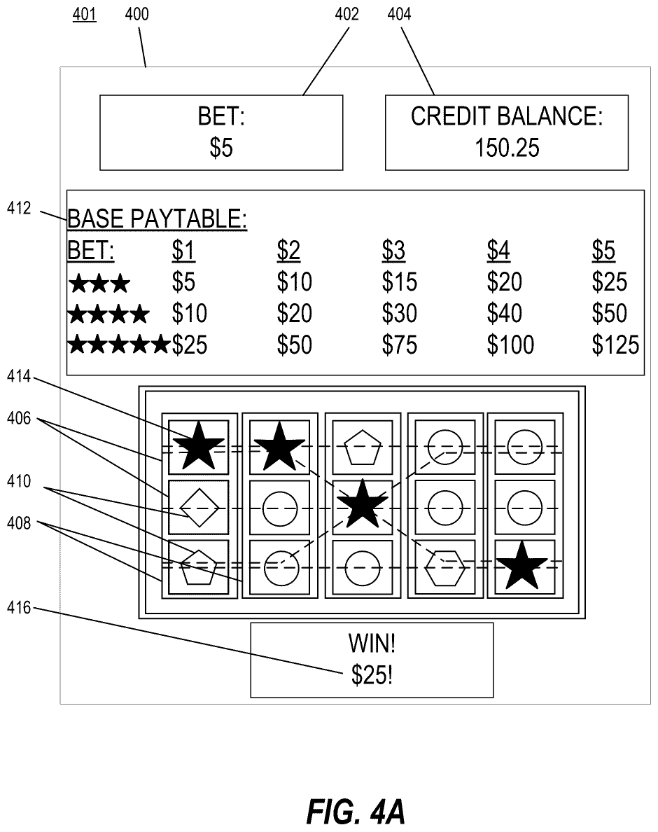

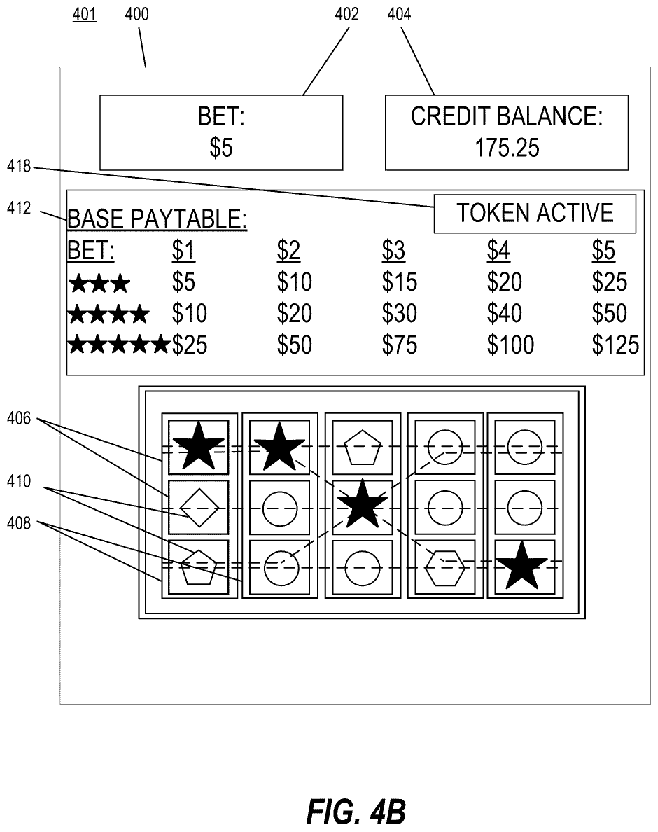

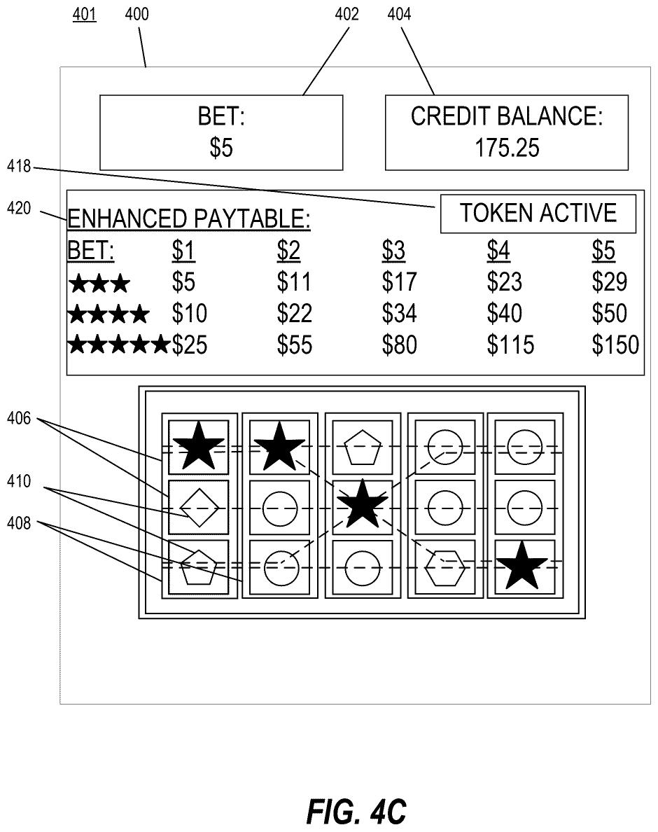

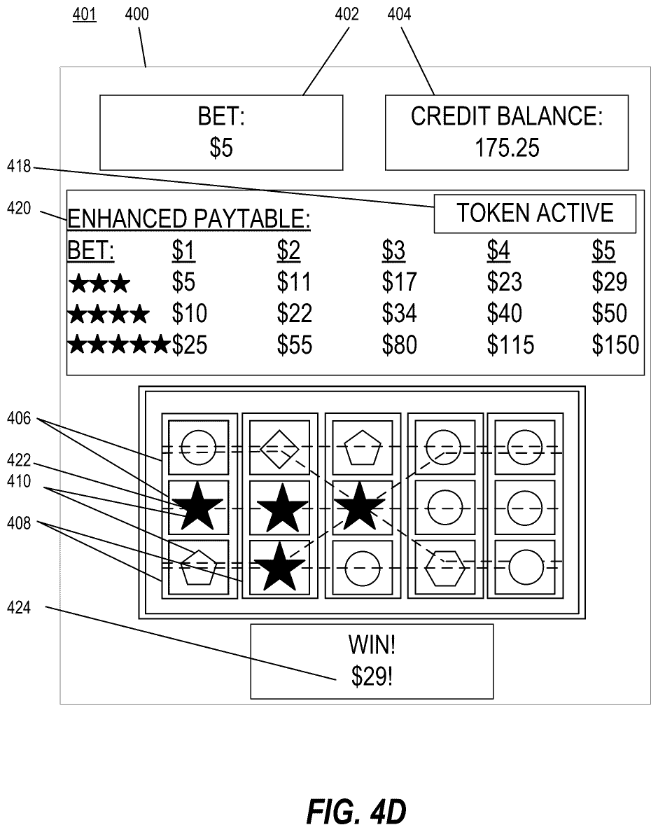

FIGS. 4A-4D illustrate a graphical user interface (GUI) for providing a cryptographic token enabled paytable modification for a wagering game at a gaming device, according to some embodiments.

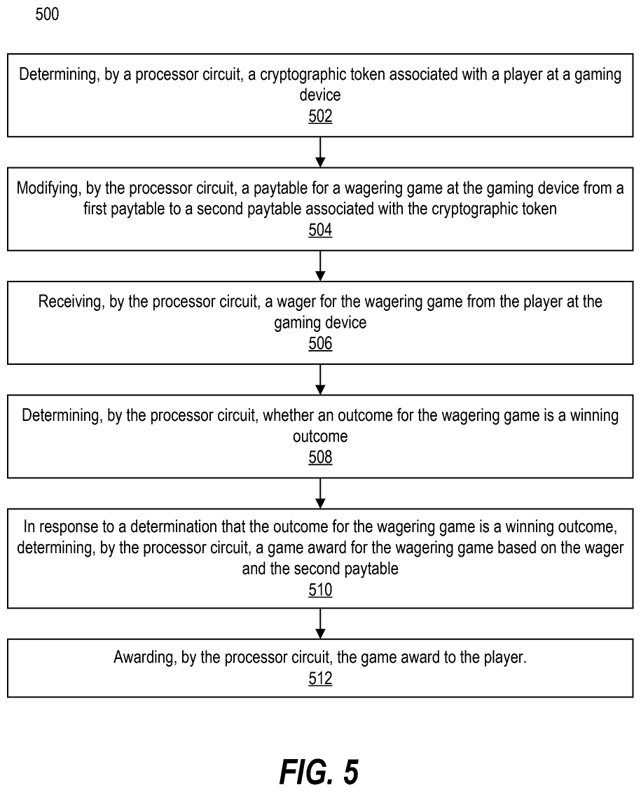

FIG. 5 is a flowchart illustrating operations of systems/methods of providing a cryptographic token enabled paytable modification for a wagering game, according to some embodiments.

### DETAILED DESCRIPTION

Embodiments described herein relate to game play features with wagering games, and in particular to paytable modifications for wagering in a gaming environment, such as in a casino environment, using cryptographic tokens, and related devices, systems, and methods.

In some examples, cryptographic tokens may be earned during a play session to offer beneficial paytable enhancements, such as modifying a paytable or owning a unique paytable, current and/or future gameplay on the same and/or different gameplay channels. In some examples, the paytable enhancement may include an increased Return to Player (RTP) percentage, and/or a change in volatility, and may be based on the player's preferences, which may be provided by the player directly and/or which may be determined based on the player's play history and/or other factors.

One technical advantage of these and other arrangements is that paytable enhancements can be tied to specific cryptographic tokens, which may be limited in number and/or associated with specific games, thereby allowing game benefits to be provided in a targeted and controlled manner, while also generating a variety of player experiences that can increase player enjoyment and engagement.

In some examples, each cryptographic token may store certain information, including a limited version number, associated casino game(s), available denom(s) with corresponding RTP percentage(s), specific progressive odds, specific bonus frequencies, unique bonuses, reduced bonus triggering requirements, etc. In some examples, the cryptographic tokens may be traded and/or sold among players, and the number of permitted transactions may be limited or unlimited, as desired. In some examples, each cryptographic token may reduce in value and/or expire after a predetermined number of uses and/or predetermined time period.

In some examples, cryptographic tokens may be awarded at Electronic Gaming Machines (EGM), and can be used for enhanced play. For example, a slot-style game at an EGM may include a watermark symbol, e.g., an overlay for an existing slot symbol. In response to a predetermine set of criteria, such as a slot symbol including the watermark symbol in combination with a bonus being triggered, the player may be awarded a cryptographic token, which may include stored paytable enhancements that are specific to the token and that are owned by the player, e.g., by the player storing the token in an associated digital wallet.

In some examples, token ownership and/or usage may unlock stored paytable enhancements. For example, a base paytable may be a linear paytable, i.e., where the RTP percentage for the game is constant, regardless of the size of the wager, and a token enhancement may modify the paytable to be a non-linear paytable, where larger wagers may result in increased RTP percentages. In some examples, the token may include metadata with information and details regarding the paytable changes and/or enhancements. For example, the EGM may not include the enhanced paytable information itself, but may instead retrieve enhanced paytable information from the token (and/or from a network-connected device, e.g., an internet server) when the token is used and/or redeemed, as needed. In some examples, a token may include a unique paytable that is specific to the token and that is not available on any other token or other source. In some examples, the enhanced paytable may include a mixed paytable including a mix of traditional currency and cryptocurrency, cryptographic tokens, etc.

In some examples, increased RTP on a non-linear table may be achieved by increasing bonus frequency, improved odds for winning larger jackpots, and/or by awarding additional nonmonetary bonus awards, such as cryptographic tokens, in addition to base monetary awards. In this manner, a base paytable may remain linear, while additional awards may be awarded via the enhanced paytable, thereby providing a non-linear mixed paytable. For example, a standard paytable for a video poker game may pay a set monetary amount (e.g., 50 credits in one currency) for a particular outcome (e.g., 5 aces), while an enhanced paytable may pay a combination of currencies (e.g., dollars and cryptocurrency), with the proportions being determined on a sliding scale, based on the player's cryptographic token criteria. In some examples, the token may be used and/or redeemed to switch between the standard paytable and mixed paytable options.

In some examples, the token may enable modifications of prize values for different outcomes. For example, a token may enable a player to swap prize values between outcomes or symbols (e.g., Kings and Aces in a video poker game). In some examples, the underlying math may be arranged so that there is no change and/or minimal change to RTP, while still increasing player engagement and enjoyment

In some examples, a weighted award table may be used to award cryptographic tokens at a higher rate to players that are wagering more or at higher denominations. The weighted award table may award more tokens and/or rarer/more valuable tokens as play frequency and/or amounts increase. In some examples, increased or higher-level play may modify the value of existing tokens, e.g., increasing the value, number of redemptions, etc. of the token based on gameplay. In some examples, tokens may increase in value based on any number of factors, such as a number of times the token is enabled when playing a specific game, a number of times threshold wagers are met and maintained over a predetermined amount of coin-in and/or spins, a number of times the token is used in a group play session with other token holders that also met a minimum play threshold, etc. In some examples, tokens may decrease in value based on any number of factors, such as a number of times the token is traded or sold, a number of times a special feature, e.g., a multiplier, free spin bonus, upgraded reels, etc., is used, etc. For examples, a player may use a token to activate an enhanced paytable, e.g., providing increased odds to hit a progressive bonus during a predetermined number of games, with the amount of the increase increasing or reducing with each subsequent activation of the feature, and with the odds returning to their initial value once the bonus is hit.

In some examples, the ability to sell or exchange tokens may be tied to certain criteria, such as a threshold level of play, play of particular game and/or at a particular number of locations, a minimum amount wagered, ownership of the token for a minimum amount of time, winning a progressive or other award with the enhanced paytable active, etc.

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

Embodiments herein may include different types of gaming devices. One example of a gaming device includes a gaming device 100 that can use gesture and/or touch- based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in

FIG. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Referring now to FIG. 3, a schematic block diagram illustrates various operations for a blockchain transaction recordation according to some embodiments. As illustrated in FIG. 3, transactions 302 may occur at various blockchain nodes. In accordance with various embodiments, a hash may be created for each entry. For example, a cryptographic hash function may create a one-way, (essentially) collision free signature of the entry. The hash algorithm generates a hash. Using hashing function 304, hash values 306 of these transactions are created and added to blockchain blocks 308 that are in the blockchain data structure.

In this example, each blockchain block 308 may include one or more different types of data. For example, each blockchain block 308 may include cryptographic hash data 310 indicative of a result of the hashing function 304 associated with a common blockchain, token identifier data 312 indicative of an identity of a cryptographic token 314 associated with the block 308, common identifier data 316 indicative of the cryptographic token 314 being part of a plurality of cryptographic tokens, e.g., a defined subset of tokens based on different criteria, associated with the common blockchain, player identifier data 318 indicative of an identity of a player associated with the cryptographic token 314, transaction identifier data 320 associated with the unique transaction on the blockchain, which may include a sending address 322 associated with a provider of the cryptographic token 314 and a receiving address 324 associated with the player identifier data 318.

The cryptographic token 314 may include some or all of the data structure of the respective associated block 308 and/or may contain a block identifier 325 referring to the associated block 308, which allows the cryptographic token 314 to be securely and transparently authenticated against the blockchain. In some examples, the cryptographic token 314 may include a common identifier 326 corresponding to the common identifier data 316 and indicative of the cryptographic token 314 being part of the plurality of cryptographic tokens, and a player identifier 328 corresponding to the player identifier data 318 and indicative of a player associated with the cryptographic token 314. The cryptographic token 314 may include a unique transaction identifier 330 associated with a unique transaction on the blockchain, i.e., a unique block 308, and may include the sending address 322 and/or the receiving address 324.

For example, a new transaction for the cryptographic token may include transmitting a transaction indication of the new transaction including a sending address 322 and receiving address 324, and, based on the transaction indication, modifying the player identifier data 318 in a new block 308 and/or the player identifier 328 of the cryptographic token 314 to be indicative of a different player.

In some examples, each block 308 may further include paytable enhancement identifier data 332 associated with a paytable enhancement feature 334, such as a modification of an existing paytable or a replacement paytable for a wagering game. Each cryptographic token 314 may be a fungible token that is fungible with other cryptographic tokens, and/or may further include a unique identifier 340, which may correspond to the token identifier data 312 of the block 308, such that the cryptographic token 314 is a non-fungible token that is not fungible with other cryptographic tokens.

As a general principle, a validation process may be performed to ensure that each new blockchain block 308 meets the criteria for inclusion into the blockchain data structure. In a blockchain configuration, there are varying consensus algorithms that can be used. For example, a private blockchain may choose an algorithm such as Practical Byzantine Fault Tolerance (PBFT). The PBFT mechanism may be useful for small networks, such as networks having fewer than about 100 nodes. Other examples include a Proof of Work (PoW) consensus algorithm and/or a Proof of Stake (PoS) consensus algorithm, which may be used as the value of an underlying data block and/or value changes.

Referring now to FIGS. 4A-4D, a graphical user interface (GUI) 400 is illustrated for providing a cryptographic token enabled paytable modification for a wagering game at a gaming device 401. As shown by FIG. 4A, the GUI 400 may include a bet button 402, a credit meter 404, and a plurality of primary game elements 406 for a primary wagering game, such as a plurality of slot reels 408 and slot symbols 410 for example. As shown by FIG. 4A, during play of the wagering game, a base paytable 412 is active by default. In this example, the base paytable 412 is a linear paytable, with a predetermined RTP percentage and a set of winning outcomes associated with a first set of awards. For example, as shown in FIG. 4A, a particular outcome 414 results in a predetermined game award 416 based on the base paytable 412.

As shown in FIG. 4B, the system may determine a cryptographic token associated with a player at the gaming device 401. In this example, the GUI 400 may include a token indicator 418 indicative of an active cryptographic token associated with the player. In some examples, the cryptographic token may include a fungible token that is interchangeable with a plurality of cryptographic tokens and/or a unique non-fungible token, as desired.

As shown in FIG. 4C, the token may be used to modify the base paytable 412 to a more favorable enhanced paytable 420 associated with the cryptographic token. For example, modification of the paytable may be based on redemption of the cryptographic token by the player. In some examples, the cryptographic token may have a redemption limit value, such that redemption of the cryptographic token is limited to a predetermined number of redemptions equal to the redemption limit value.

In this example the paytable 420 has a larger RTP percentage than the RTP percentage of the base paytable 412. In this example, the modification of the base table 412 to the enhanced paytable 420 may be further based on the player meeting a game play threshold, such as a minimum number of games played by the player in a predetermined time period, a minimum amount wagered by the player in a predetermined time period, a minimum amount won by the player in a predetermined time period, a minimum amount lost by the player in a predetermined time period, and/or any other criteria, as desired.

As shown in FIG. 4D, in response to receiving the same wager amount and determining the same or equivalent winning outcome 422 as the outcome 414 in FIG. 4A, a different game award 424 (i.e., a more favorable award in this example) from the award of FIG. 4A is awarded to the player. Alternatively or in addition, the enhanced paytable 420 may have a volatility value, bonus frequency value, or other criteria that are different, e.g., larger or smaller, than corresponding criteria of the base paytable 412, as desired. In some examples, the enhanced paytable 420 may be a unique paytable. The enhanced paytable may have its own set of winning outcomes, which may be the same as or different from the set of winning outcomes of the base paytable 412, associated with a second set of awards, which may be equal to or different from the corresponding awards of the first set of awards, as desired.

FIG. 5 is a flowchart illustrating operations 500 of operations of systems/methods of providing a cryptographic token enabled paytable modification for a wagering game, according to some embodiments. The operations 500 may be performed by one or more processor circuits of one or more computing devices, such as any of the computing devices described herein, for example. The operations 500 may include determining, by a processor circuit, a cryptographic token associated with a player at a gaming device (Block 502). The operations 500 may further include modifying, by the processor circuit, a paytable for a wagering game at the gaming device from a first paytable to a second paytable associated with the cryptographic token (Block 504). The operations 500 may further include receiving, by the processor circuit, a wager for the wagering game from the player at the gaming device (Block 506). The operations 500 may further include determining, by the processor circuit, whether an outcome for the wagering game is a winning outcome (Block 508). The operations 500 may further include, in response to a determination that the outcome for the wagering game is a winning outcome, determining, by the processor circuit, a game award for the wagering game based on the wager and the second paytable (Block 510). The operations 500 may further include awarding, by the processor circuit, the game award to the player (Block 512).

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet, or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory comprising machine readable instructions that, when executed by the processor circuit, cause the processor circuit to:
determine a cryptographic token associated with a player at a gaming device;
modify a paytable for a wagering game at the gaming device from a first paytable to a second paytable associated with the cryptographic token;
receive a wager for the wagering game from the player at the gaming device;
determine whether an outcome for the wagering game is a winning outcome;
in response to a determination that the outcome for the wagering game is a winning outcome, determine a game award for the wagering game based on the wager and the second paytable; and
award the game award to the player.

2. The system of claim 1, wherein the first paytable comprises first Return To Player (RTP) percentage, and
wherein the second paytable comprises a second RTP percentage larger than the first RTP percentage.

3. The system of claim 1, wherein the first paytable comprises a first volatility value, and
wherein the second paytable comprises a second volatility value larger than the first volatility value.

4. The system of claim 1, wherein the first paytable comprises a first bonus frequency value, and
wherein the second paytable comprises a second bonus frequency value larger than the first bonus frequency value.

5. The system of claim 1, wherein the first paytable comprises a standard paytable for the wagering game, and
wherein the second paytable comprises a unique paytable.

6. The system of claim 1, wherein the first paytable comprises a first set of winning outcomes associated with a first set of awards, and
wherein the second paytable comprises a second set of winning outcomes associated with a second set of awards, the second set of winning outcomes being different from the first set of winning outcomes.

7. The system of claim 6, wherein each award of the second set of awards equals a corresponding award of the first set of awards.

8. The system of claim 6, wherein the second set of awards is different from the first set of awards.

9. The system of claim 1, wherein the modification of the paytable is further based on the player meeting a game play threshold.

10. The system of claim 9, wherein the game play threshold comprises a minimum number of games played by the player in a predetermined time period.

11. The system of claim 9, wherein the game play threshold comprises a minimum amount wagered by the player in a predetermined time period.

12. The system of claim 9, wherein the game play threshold comprises a minimum amount won by the player in a predetermined time period.

13. The system of claim 9, wherein the game play threshold comprises a minimum amount lost by the player in a predetermined time period.

14. The system of claim 1, wherein the modification of the paytable is further based on redemption of the cryptographic token by the player.

15. The system of claim 14, wherein the cryptographic token comprises a redemption limit value, wherein redemption of the cryptographic token is limited to a predetermined number of redemptions equal to the redemption limit value.

16. A gaming device comprising:
a communication interface;
an input device;
a processor circuit; and
a memory comprising machine readable instructions that, when executed by the processor circuit, cause the processor circuit to:
determine, via the communication interface, a cryptographic token associated with a player at a gaming device;
modify a paytable for a wagering game at the gaming device from a first paytable to a second paytable associated with the cryptographic token;
receive, via the input device, a wager for the wagering game from the player at the gaming device;
determine whether an outcome for the wagering game is a winning outcome;
in response to a determination that the outcome for the wagering game is a winning outcome, determine a game award for the wagering game based on the wager and the second paytable; and
award the game award to the player.

17. The gaming device of claim 16, wherein the first paytable comprises first Return To Player (RTP) percentage, and
wherein the second paytable comprises a second RTP percentage larger than the first RTP percentage.

18. The gaming device of claim 16, wherein the first paytable comprises a first volatility value, and
wherein the second paytable comprises a second volatility value larger than the first volatility value.

19. The gaming device of claim 16, wherein the first paytable comprises a first set of winning outcomes associated with a first set of awards, and
wherein the second paytable comprises a second set of winning outcomes associated with a second set of awards, the second set of winning outcomes being different from the first set of winning outcomes.

20. A method comprising:
determining, by a processor circuit, a cryptographic token associated with a player at a gaming device;
modifying, by the processor circuit, a paytable for a wagering game at the gaming device from a first paytable to a second paytable associated with the cryptographic token;
receiving, by the processor circuit, a wager for the wagering game from the player at the gaming device;
determining, by the processor circuit, whether an outcome for the wagering game is a winning outcome;
in response to a determination that the outcome for the wagering game is a winning outcome, determining, by the processor circuit, a game award for the wagering game based on the wager and the second paytable; and
awarding, by the processor circuit, the game award to the player.
